(19) United States
(12) Patent Application Publication
(10) Pub. No.: US 2014/0131337 A1
(43) Pub. Date: May 15, 2014

(54) Electrode Holder with Automatic Power Cutoff

(71) Applicant: Donny R. Williams, Pax, WV (US)

(72) Inventor: Donny R. Williams, Pax, WV (US)

(21) Appl. No.: 13/677,414

(22) Filed: Nov. 15, 2012

(51) Int. Cl. B23K 37/00

(52) U.S. Cl. CPC B23K 37/00
USPC 219/138

(57) ABSTRACT

An electrode holder is provided for use in stick welding. The electrode holder comprises a handle, and an electrode gripping mechanism fitted to the first opposite end of the handle. The electrode gripping mechanism comprises upper and lower jaw members. The upper jaw member extends above the handle for a distance from one end of the handle. In one non-limiting embodiment a handle switch is located on the handle and below the upper jaw member. The handle switch is in operable communication with a power shutoff located between the electrode holder and a power supply. The location of the handle switch obviates the need for conscious effort on the part of a user to electrically isolate the electrode holder when changing an electrode.

### CROSS-REFERENCE TO RELATED APPLICATIONS

Not Applicable.

### STATEMENT REGARDING FEDERALLY SPONSORED RESEARCH OR DEVELOPMENT

Not Applicable.

### FIELD OF THE INVENTION

This invention relates to electrode holders used in stick welding; also referred to as shielded metal arc welding (SMAW). More specifically, the invention is an electrode holder which routinely and reliably cuts off power upstream of the electrode holder during electrode changes without requiring conscious action by a user.

### BACKGROUND OF THE INVENTION

As noted in U.S. Pat. No. 3,828,160, the prior art discloses switch constructions disposed in the handle portions of electrode holders such as U.S. Pat. Nos. 3,249,734, 1,589,977; and 1,883,807. In contrast, U.S. Pat. No. 3,596,052 discloses the typical and more common type of handle construction which has no provision for disconnecting the power.

Again as noted in U.S. Pat. No. 3,828,160, in the construction disclosed in each of these patents, the power disconnect switch requires intricate switch design with a plurality of moving parts, all requiring the operator to manipulate the switch by hand. Due to the design of the switch throw, the welder must remove his heavy working gloves and operate a switch button or manipulate a plurality of switch buttons. Likewise, when the power button is to be energized, the reverse procedure is necessary. Furthermore, the maintenance of the intricate designs disclosed in the prior art is difficult.

Welding machines, by their nature, are employed in very hostile environments and receive very rough use. They are subjected to dirt and dust as well as temperature extremes and abuse by the operators. Moving parts are oftentimes rendered inoperative due to dirt and dust and delicate mechanisms are oftentimes damaged due to the rough treatment which this type of equipment is subjected to. Furthermore, the environment in which this equipment is used requires the operator to wear heavy, long-cuffed gloves which substantially interfere with finger and hand dexterity. U.S. Patent Publication Number 20060086709 describes an electrode holder for use in welding with a power isolating switch on the handle. The power isolating switch can lock the electrode against removal when the power isolating switch is in the “on” position. When the power isolating switch is moved to the “off” position, the electrode can be removed. The electrode holder provides significant safety improvements to minimize a shock hazard to a user changing electrodes.

U.S. Pat. No. 7,825,351 describes a hand held electrode holder fitted with a power on/off switch on the handle of the electrode holder and a trigger to open the clamping jaws that clamp the electrode. The holder has internal parts which operate such that the trigger cannot open the clamping jaws while the switch is in the power on position thereby reducing the possibility of an electric hazard when changing electrodes.

U.S. Pat. No. 3,828,160 describes an electrode holder with power disconnect. The '160 electrode holder is fitted with a plug and socket type of electrical connection mounted inside the insulated handle portion of the electrode. The plug and socket are mounted for relative sliding movement inside the handle.

U.S. Patent Publication Number 20060237410 describes a manual welding safety disconnect which allows a welder to stop current flow to a TIG (GTAW) torch or a stick (SMAW) welding lead where it attaches to the supply cable which would allow the operator to prevent further current flow by causing a misalignment of the enclosed electrical contacts. Misalignment of the electrical contacts by a rotation around the inert gas tube permits the operator to immediately shut off the welding current while still allowing the gas flow in the TIG version. This configuration also is more convenient for the welder since he would not have to leave his work area. This safety device would reduce the risk of electric shock, accidental arc strike, and arc flash. This device can isolate any one lead or torch to produce a safe zero energy mode even if operating from a multibank power supply. None of the above inventions and patents, taken either singly or in combination, is seen to describe the instant invention as claimed.

### SUMMARY

The invention is directed to an electrode holder system used in stick welding. The electrode holder comprises a handle having first and second opposite ends, and an electrode gripping mechanism fitted to the first opposite end of the handle. The electrode gripping mechanism comprises upper and lower jaw members. The upper jaw member extends above the handle for a distance from the first opposite end of the handle.

In one non-limiting embodiment a handle switch is located on the handle and below the upper jaw member. The handle switch is in operable communication with a power shutoff located between the electrode holder and a power supply. The location of the handle switch obviates the need for conscious effort on the part of a user to electrically isolate the electrode holder when changing an electrode. More specifically, the location of the handle switch ensures that during normal operation of the electrode holder a user is obliged without conscious effort to press the handle switch when gripping the handle thereby supplying power to the electrode holder, and upon replacing an exhausted electrode a user, without conscious effort, releases the handle switch thereby cutting off power to the electrode holder.

Since the power shutoff is located upstream of the electrode holder no electrical power is supplied to the electrode holder when the user is changing or fitting an electrode between the upper and lower jaw members thereby avoiding accidental electrocution of the user. Also, if the electrode holder is dropped while live, the power is immediately shut off upstream of the electrode holder thereby avoiding accidental electrocution of the user and/or nearby workers. As such, the invention offers significant safety improvements to minimize a shock hazard to a user changing electrodes.

### BRIEF DESCRIPTION OF THE DRAWINGS

FIG. 1 shows a perspective environmental view of an electrode holder in combination with the power shutoff device according to the present invention.

FIG. 2 shows a perspective view of a power shutoff device in combination with an electrode holder according to the present invention.

FIG. 3 shows a top view of a power shutoff device according to the invention.

FIG. 4 shows an electrode holder being held by a user's hand with the user's hand 190 holding down an upper jaw member.

FIG. 5 shows an electrode holder being held by a user's hand with the user's hand pressing down a trigger switch.

FIG. 6 shows a longitudinal section view of the electrode holder corresponding to line 6-6 in FIG. 4.

FIG. 7 shows a section view of a second power line corresponding to line 7-7 in FIG. 5.

FIG. 8 shows a schematic of a power cutoff circuit according to one embodiment of the present invention.

FIG. 9 shows a schematic of a power cutoff circuit according to one embodiment of the present invention.

FIG. 10 shows a schematic of a power cutoff circuit according to one embodiment of the present invention.

FIGS. 11A and 11B show a table of parts.

Similar reference characters denote corresponding features consistently throughout the attached drawings.

### DESCRIPTION OF THE PREFERRED EMBODIMENTS OF THE INVENTION

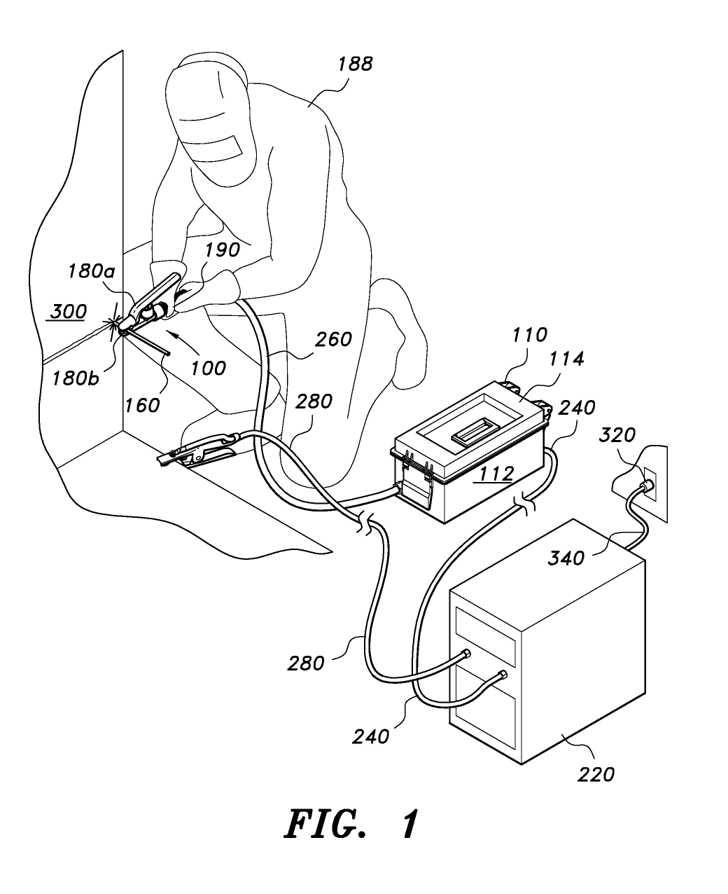

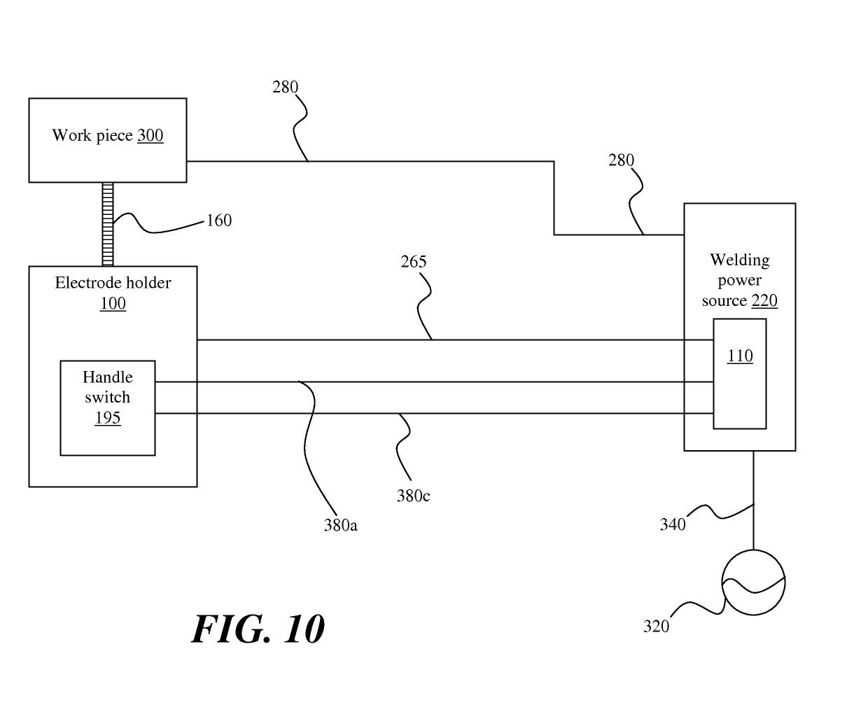

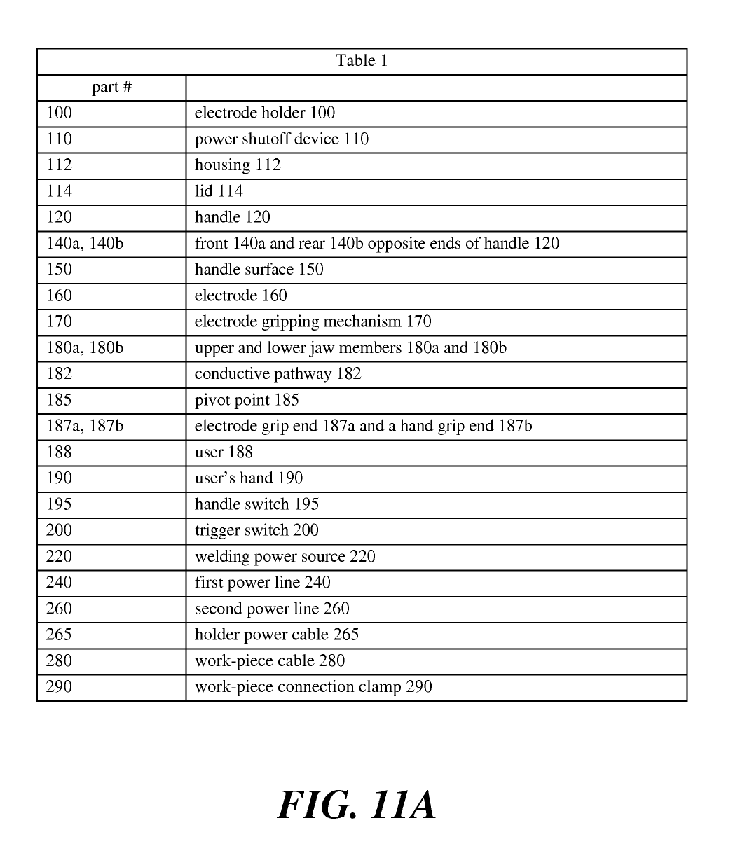

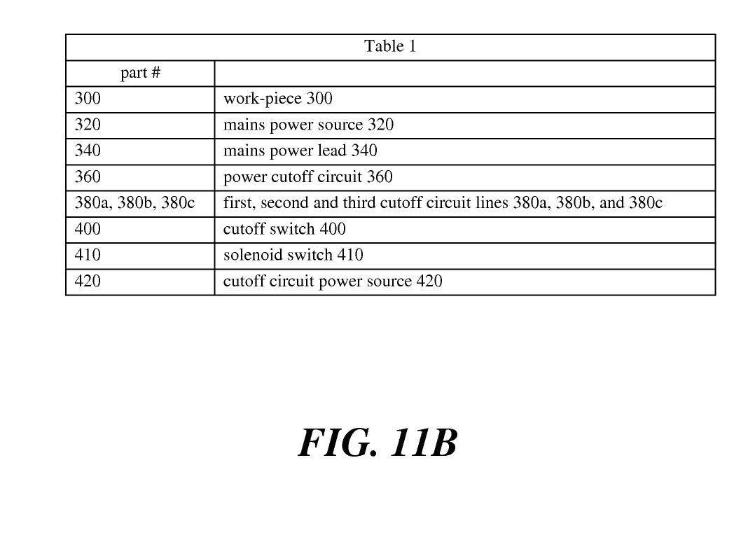

This invention is directed to electrode holders used in stick welding; also referred to as shielded metal arc welding (SMAW). In one embodiment, the invention is an electrode holder 100 with the capability of cutting off power upstream of the electrode holder 100 during electrode changes without requiring conscious action by a user. In another embodiment, the invention is an electrode holder 100 in combination with a power shutoff device 110. The power shutoff device 110 is used to cutoff power upstream of the electrode holder 100 depending on the status of the handle switch 195. The power shutoff device 110 can be a modular unit located between the electrode holder 100 and a welding power source 220 (as shown in FIG. 1) or can be merged with or form an integral part of a welding power source 220 (as shown schematically in FIG. 10). In this embodiment the power shutoff device 110 comprises cutoff switch 400 and said cutoff circuit power source 420, and since the power shutoff device 110 is located inside welding power source 220 the power shutoff device 110 may or may not include housing 112 or lid 114. A description of part numbers is found in Table 1 (see FIGS. 11A and 11B).

It is to be understood that the terms “top”, “bottom”, “side”, “front”, “rear”, “upper”, “lower”, “vertical”, “horizontal”, “height”, “width”, “length” and the like are used herein merely to describe points of reference and do not limit the present invention to any specific orientation or configuration. The claimed apparatus and components may be of any size, shape or configuration suitable for operation of the apparatus and may be constructed of any suitable materials.

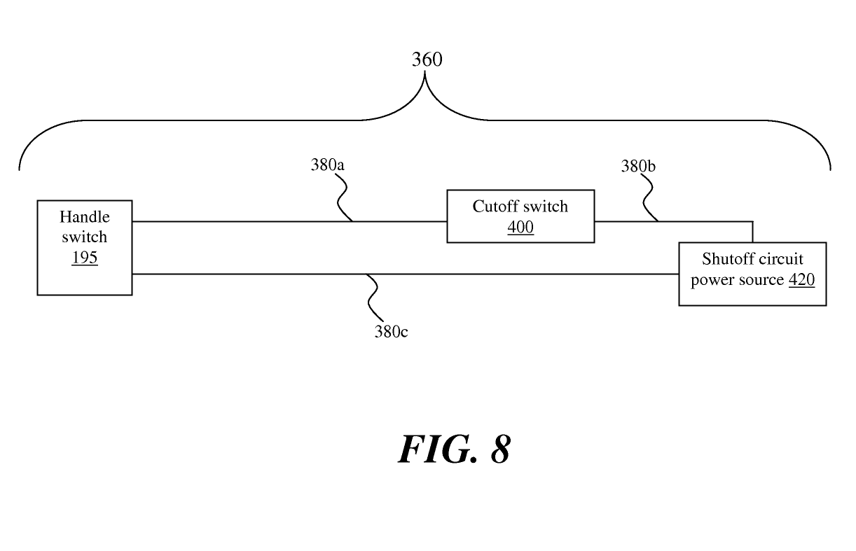

The electrode holder 100 comprises a handle 120 in the shape of a tube and having front 140a and rear 140b opposite ends, handle surface 150, a handle switch 195, and an electrode gripping mechanism 170 fitted to or proximate to the front opposite end 140a of handle 120. The handle switch 195 (shown schematically in FIGS. 8, 9 and 10) can be any suitable switch that responds to human hand pressure such as a trigger switch 200.

The electrode gripping mechanism 170 can be any suitable electrode gripping mechanism for gripping an electrode 160 such as upper and lower jaw members 180a and 180b, respectively.

The upper jaw member 180a extends above the handle 120 for a predetermined distance from the front opposite end 140a of the handle 120. The predetermined distance can be any suitable distance such that a user is obliged without conscious effort to place their hand (typically an insulated gloved hand) under the upper jaw member and press down the handle switch 195, which can be a trigger switch 200, when gripping the handle 120 to perform stick welding operations; and, further wherein a user is obliged to release the handle switch 195, which can be a trigger switch 200, upon gripping and pressing the upper jaw member 180a towards the surface 150 of the handle 120 via pivot point 195 to release an electrode 160 from between the upper and lower jaw members 180a and 180b.

The predetermined distance can be in the range 10% to 100% of the length of the handle 120, wherein the length of the handle 120 is defined as the distance between the front 140a and rear 140b opposite ends of handle 120. More preferably, the predetermined distance can be in the range 20% to 80% of the length of the handle 120, wherein the length of the handle 120 is defined as the distance between the front 140a and rear 140b opposite ends of handle 120. Still more preferably, the predetermined distance can be in the range 30% to 60% of the length of the handle 120, wherein the length of the handle 120 is defined as the distance between the front 140a and rear 140b opposite ends of handle 120.

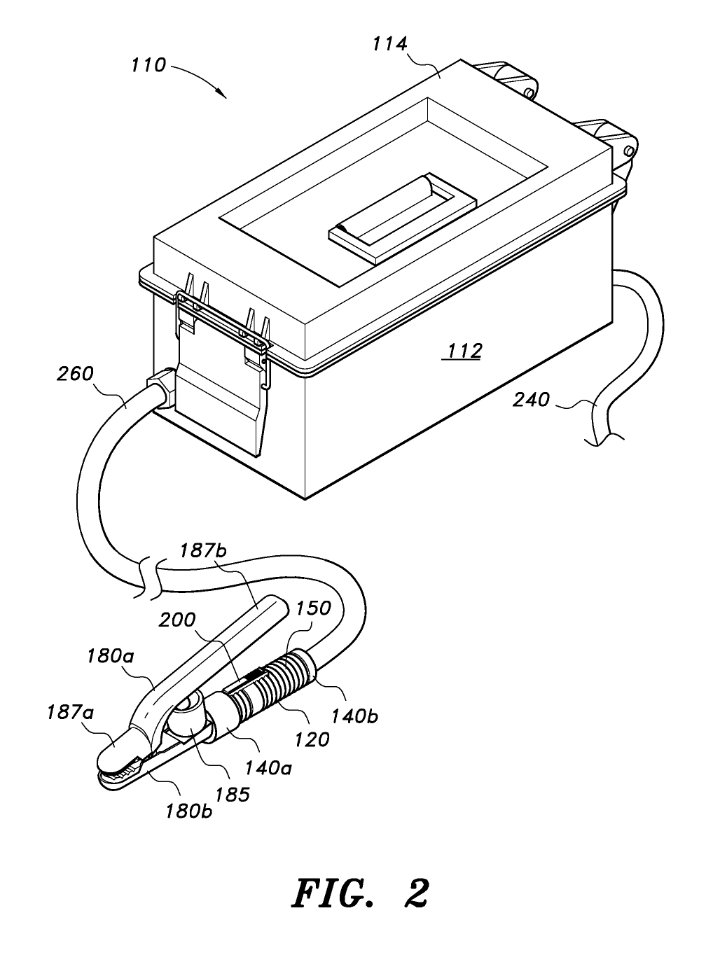

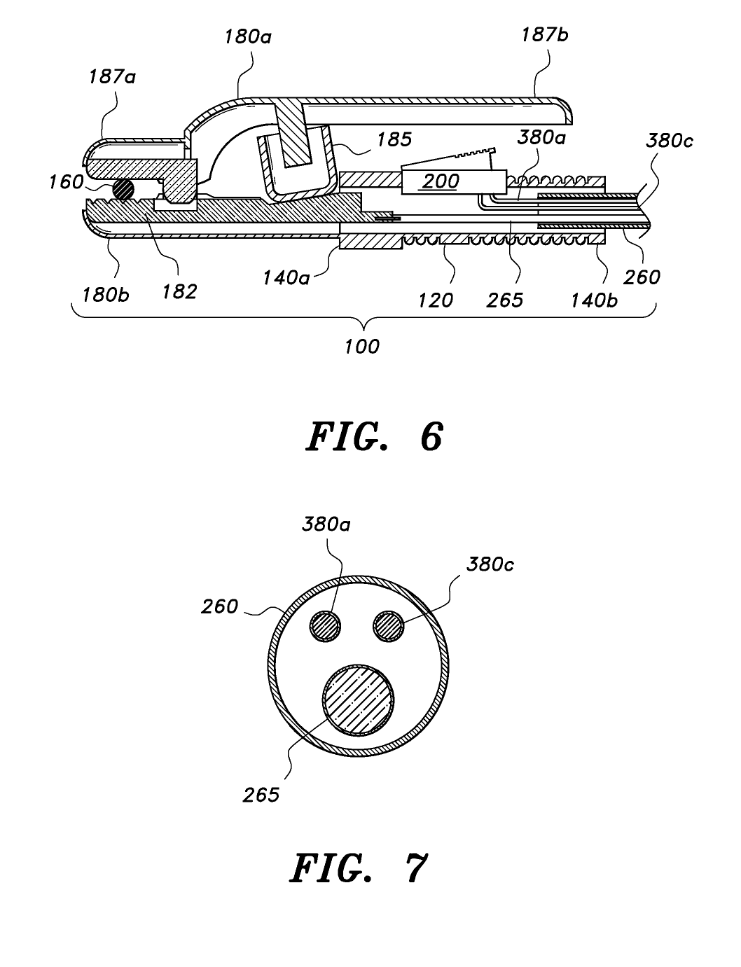

The handle switch 195 is located on any suitable part of the handle 120 which obliges a user to release the handle switch 195 upon using the jaws 180a and/or 180b to release or attach an electrode 160 to the electrode holder 100. In this manner a user 188 is consciously or unconsciously obliged to remove their hand 190 from pressing the handle switch 195 when, for example, an electrode 160 needs to be replaced or otherwise inserted between jaws 180a and 180b. It is also preferred that the handle switch 195 is located in such a position on the handle 120 that a user 188 is obliged to press the handle switch 195 upon gripping the handle 120 to perform a stick welding operation and more preferably to release the handle switch 195 upon pressing upper jaw 180a towards handle surface 150 about pivot 185 to release or insert a fresh electrode 160 between upper and lower jaw members 180a and 180b. The handle switch 195 can be a trigger switch 200 as shown, for example, in FIGS. 2 and 6.

In one non-limiting embodiment a trigger switch 200 is located on the handle surface 150 below the upper jaw member 180a; it has been found that locating a trigger switch 200 below the upper jaw member 180a obliges a user 188 to press the trigger switch 200 when gripping the handle 120, and conversely upon changing a used electrode 160 the user's hand 190 must be used to press the upper jaw member 180a inwards towards the handle surface 150, the process of pressing the upper jaw member 180a requires the user 188 to remove his/her hand 190, typically a gloved hand, out of the way to avoid blocking the upper jaw member 180a which needs to be pressed downwards towards the handle's surface 150 in order to release a spent electrode 160 from between the jaws 180a and 180b. The upper jaw member 180a also needs to be pressed downwards towards the handle's surface 150 in order to insert a fresh electrode 160 between the jaws 180a and 180b.

The upper jaw member 180a has an electrode grip end 187a and a hand grip end 187b, and during electrode changes the hand grip end 187b is pressed inwards towards the handle surface 150 to release a used electrode or to fit a fresh electrode between the upper and lower jaws 180a and 180b (see FIG. 6). In pressing the handle grip end 187b a user 188 is obliged to remove their hand 190 from beneath the upper jaw 180a thereby releasing the trigger switch 200 which in turn causes a power shutoff device 110 to cut power upstream of the handle 120 and hence upstream of the electrode holder 100 thereby stopping electrical power reaching the electrode holder 100 and further thereby rendering the electrode holder 100 safe for a user 188 to change or replace an electrode 160.

In one non-limiting embodiment at least one of the jaws 180a, 180b is in contact with or forms part of a conductive pathway 182; in FIG. 6 the lower jaw member 180b is operatively attached to the conductive pathway 182. In this embodiment the conductive pathway 182 is connected to holder power cable 265; the conductive pathway 182 includes that portion of the holder power cable 265 located inside the handle 120. As stated elsewhere, a handle switch 195 is located on any suitable part of the handle 120, but it is preferred that a handle switch 195 in the form of a trigger switch 200 is located on the surface 150 below the upper jaw member 180a.

The handle switch 195 forms part of a power cutoff circuit 360 (see FIG. 8). In one non-limiting embodiment, the power cutoff circuit 360 comprises: a handle switch 195 such as a trigger switch 200; first, second and third cutoff circuit lines 380a, 380b, and 380c; cutoff switch 400, and a cutoff circuit power source 420. The cutoff circuit power source 420 can be a DC battery such as, but not limited to, a 12 volt battery; in the alternative the cutoff circuit power source 420 can be, for example, an AC/DC converter connected to a mains AC source or the welding power source 220. The cutoff switch 400 can be any suitable cutoff switch such as, but not limited to, a solenoid switch. (The abbreviations “AC” and “DC” stand for “alternating current” and “direct current”, respectively.)

In one non-limiting embodiment a trigger switch 200 is located on the handle 120 below the upper jaw member 180a. The length of the handle 120 is selected to ensure that a user's hand has to be positioned over the handle switch 200 during welding, and the location of the handle switch 200 below the upper jaw member 180a ensures that when an electrode 160 is withdrawn or inserted between jaws 180a and 180b the user's hand 190 has to be removed from underneath the upper jaw 180a to allow the upper jaw 180a to be pressed inwards towards the handle surface 150. The handle switch 195 is in operable communication with a power shutoff device 110 located between the electrode holder 100 and a welding power source 220. The handle switch 195 defaults in an up position and in response to down pressure by a user's hand 190 the handle switch 195 moves inwards and allows electrical current to run through power cutoff circuit 360 thereby causing cutoff switch 400 to close and electrical current to transfer from a first power line 240 to a second power line 260 and thence to electrode holder 100 and thence to electrode 160. The second power line 260 includes a power cable 265, first circuit cutoff line 380a, and third circuit cutoff line 380c (see FIG. 7, which shows a cross-section view of second power line 260 at line 7-7 in FIG. 5).

Since the power shutoff device 110 is located upstream of the electrode holder 100 no electrical power is supplied to the electrode holder 100 when the user is changing or fitting an electrode 160 between the upper and lower jaw members 180a and 180b thereby avoiding accidental electrocution of the user. Also, if the electrode holder 100 is dropped while live, the switch 200 springs up and power is immediately shut off upstream of the electrode holder 100 thereby avoiding accidental electrocution of the user and/or nearby workers. As such, the electrode holder 100 offers significant safety improvements to minimize a shock hazard to a user changing electrodes.

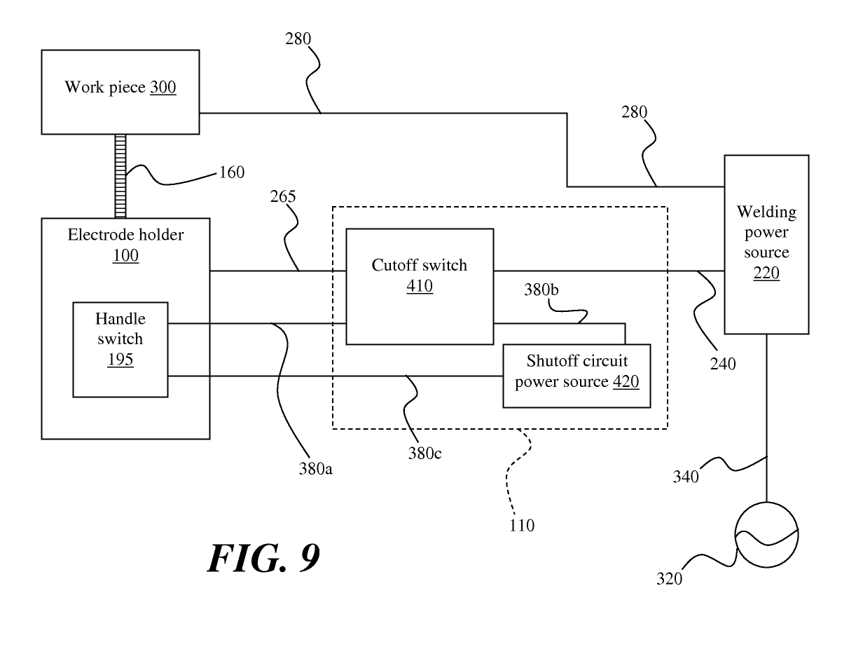

The power shutoff device 110 comprises a housing 112 and a cutoff switch 400 located therein. The cutoff switch 400 can be a solenoid switch 410 (shown schematically in, for example, FIG. 9). A first power line 240 enters the housing 112, and a second power line 260 exits the housing 112. The housing 112 had an optional lid 114 which can be a hinged lid.

The cutoff switch 400 is located between the first and second power lines 240 and 260. When the cutoff switch 400 is in a closed position electrical power can flow from the first power line 240 to the second power line 260 and hence to the electrode holder 100. When the cutoff-switch 400 is in an open position electrical power can not flow from the first power line 240 to the second power line 260 and power is cutoff upstream from the electrode holder 100.

The cutoff switch 400 defaults to an open position preventing electrical power reaching the electrode holder 100 from a welding power source 220. The cutoff switch 400 moves to a closed position in response to current received from power cutoff circuit 360 thereby allowing current to pass from first power line 240 to the second power line 260 and more particularly to the holder power cable 265 located inside the first power line 260. In addition to the cutoff switch 400 the power cutoff circuit 360 also includes a circuit power source 420 and handle switch 195; the handle switch 195 can be a trigger switch 200. Current only flows to the cutoff switch 400 when the handle switch 195 is in a pressed down condition; the position of the handle switch 195 ensures that a user's hand presses the handle switch 195 inwards upon gripping handle 120, and unconsciously releases the handle switch 195 when pressing the upper jaw member 180 inwards towards surface 150 to release a used electrode or to insert a fresh electrode 160.

The circuit power source 420 can be, for example, a non-rechargeable battery or a chargeable battery. The battery can have any suitable voltage rating such as a 12 volt DC battery. Alternatively, the circuit power source 420 can be an electrical device which draws current from the first power cable 240 and converts the current to a direct current of suitable voltage to safely operate the cutoff switch 400 when handle switch 195 is in a pressed down condition. The handle switch 195 can be any suitable switch such as a trigger switch 200. Any suitable trigger switch 200 can be used such as trigger switch part number 227798 manufactured or supplied by Miller Welder Parts available from PLC Center (A Division of Radwell International, Incorporated).

FIG. 1 shows a perspective environmental view of the electrode holder 100 in combination with the power shutoff device 110. A user 188 is shown holding an electrode holder 100 with an electrode 160 held between upper and lower jaw members 180a and 180b. Electrical power is supplied to the electrode 160 from a welding power source 220 via first electrode lead cable 240, power cutoff device 110, second electrode lead cable 260, and electrode holder 100. During normal welding operations a work-piece cable 280, which terminates in a work-piece connection clamp 290, connects the welding power source 220 to a work-piece 300. The welding power source 220 is connected to a mains power source 320 via mains power lead 340. A description of part numbers is found in Table 1 (see FIGS. 11A and 11B).

FIG. 2 shows a perspective view of a power shutoff device 110 in combination with an electrode holder 100. The electronic holder 100 has a handle surface 150 which can be made out of any suitable material that provides a surface suitable to be gripped by a user's hand 190. A description of part numbers is found in Table 1 (see FIGS. 11A and 11B).

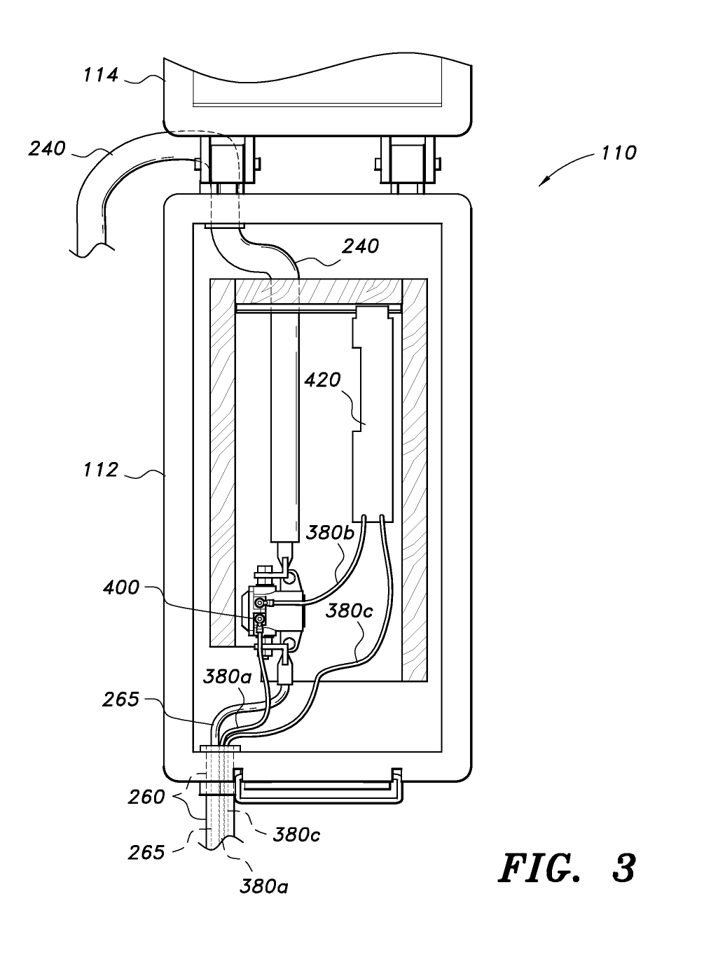

FIG. 3 shows a top view of a power shutoff device 110 with its hinged lid 114 lifted into an open position thereby revealing the apparatus located inside housing 112. The lid 114 is optional and can be replaced, for example, with a non-hinged cover. The power shutoff device 110 includes a housing 112. The housing contains a cutoff switch in the form of a solenoid switch 410, and a cutoff circuit power source 420. A description of part numbers is found in Table 1 (see FIGS. 11A and 11B). The power shutoff device 110 can be a modular unit located between the electrode holder 100 and a welding power source 220 (as shown in FIG. 1) or can be merged with or form an integral part of a welding power source 220 (as shown schematically in FIG. 10). In any event, the power shutoff is located upstream of the electrode holder 100.

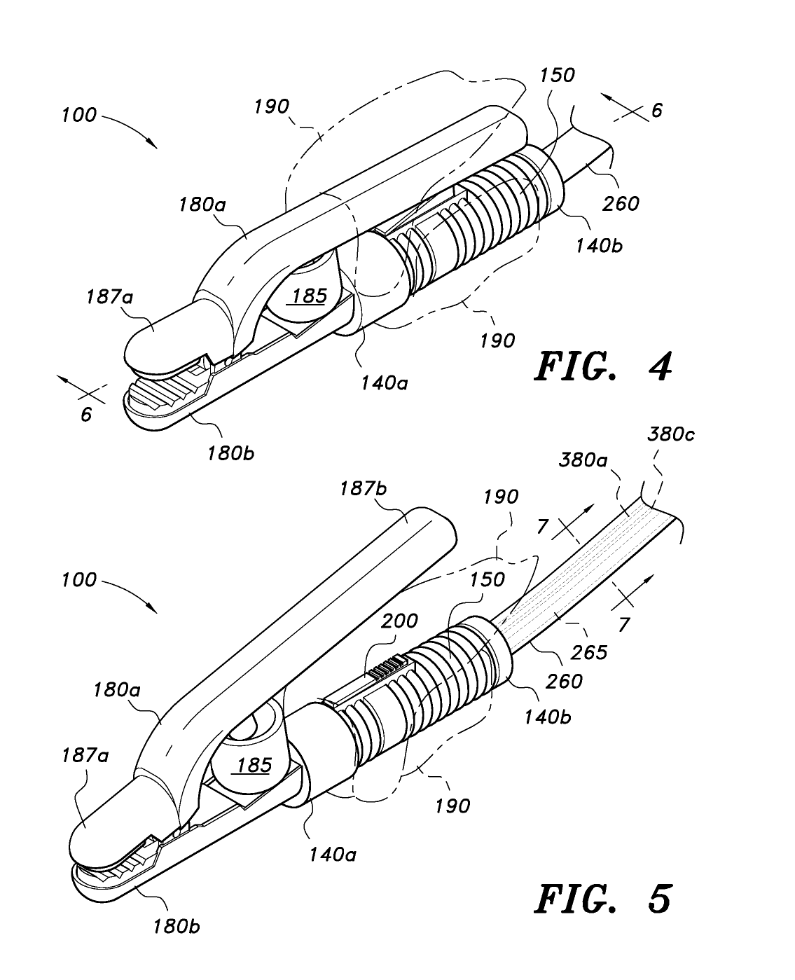

FIG. 4 shows an electrode holder 100 being held by a user's hand 190 with the user's hand 190 holding down the upper jaw member 180a to allow safe removal or replacement of an electrode 160 (not shown). The trigger switch 200 is in an up position because the user's hand 190 is not pressing down on the trigger switch 200 thereby stopping flow through power cutoff circuit 360 (shown schematically in FIG. 8) and consequently causing cutoff switch 400 to open thereby stopping the transfer of current from first power line 240 to second power line 260 and more particularly to holder power cable 265 located inside the second power line 260. A description of part numbers is found in Table 1 (see FIGS. 11A and 11B).

FIG. 5 shows an electrode holder 100 being held by a user's hand 190 with the user's hand gripping handle 120 and pressing down the trigger switch 200 thereby causing current to flow through power cutoff circuit 360 (shown in FIG. 6) and consequently causing cutoff switch 400 to close and allowing the transfer of current from first power line 240 to second power line 260 and more particularly to holder power cable 265 located inside the second power line 260. A description of part numbers is found in Table 1 (see FIGS. 11A and 11B).

FIG. 6 shows a longitudinal section view of an electrode holder 100 at line 6-6 in FIG. 4. The electrode holder 100 is shown with the upper jaw member 180a in a default up position and trigger switch 200 also in a default up position. A description of part numbers is found in Table 1 (see FIGS. 11A and 11B).

FIG. 7 shows a section view of the second power line 260 from line 7-7 of FIG. 5). The second power line 260 accommodates holder power cable 265, and first and third cutoff circuit lines 380a and 380c.

FIG. 8 shows a power cutoff circuit 360 in the form of a schematic. The power cutoff circuit 360 comprises: a handle switch 195, which can be a trigger switch 200; first, second and third cutoff circuit lines 380a, 380b, and 380c; cutoff switch 400, and a cutoff circuit power source 420; the second cutoff circuit line 380b connects the cutoff switch 400 to the cutoff circuit power source 420. The cutoff circuit power source 420 can be a DC battery such as, but not limited to, a 12 volt battery; in the alternative the cutoff circuit power source 420 can be, for example, an AC/DC converter connected to a mains AC source or the welding power source 220. The cutoff switch 400 can be any suitable cutoff switch such as, but not limited to, a solenoid switch 410 (shown schematically in, for example, FIG. 9).

FIG. 9 shows one embodiment of the invention in the form of a schematic. The holder power cable 265, first cutoff circuit line 380a, and second cutoff circuit line 380b are enclosed in holder power cable 265 (not shown in FIG. 9, but shown in FIG. 7). A description of part numbers is found in Table 1 (see FIGS. 11A and 11B).

FIG. 10 shows another embodiment of the invention in the form of a schematic. The power shutoff device 110 forms an integral part of a welding power source 220. A description of part numbers is found in Table 1 (see FIGS. 11A and 11B). FIGS. 11A and 11B show a table of parts.

It should be appreciated that the embodiments of the present invention are not limited to those specifically described above. For instance, the apparatuses of the present invention may include different structures, features, or characteristics than those described above. Similarly, the methods of the present invention may include different operations, steps, or sequences than those described above. Therefore, it is to be understood that the present invention is not limited to the embodiments described above, but encompasses any and all embodiments within the scope of the following claims.

What is claimed:

1. An electrode holder in combination with a power cutoff circuit, comprising:
a handle having a tubular shape, opposite front and rear ends, and a handle surface;
upper and lower jaw members located at the front opposite end of said handle, said upper jaw member extending for a predetermined distance above said opposite front end of said handle, said upper jaw member pivots about a pivot point in order to allow a user to remove or replace an electrode between said upper and lower jaw members;
a conductive pathway located inside said handle of which at least one of said upper and lower jaws is connected to said conductive pathway; and
a handle switch located on said handle surface and located below said upper jaw member, said handle switch being in operative communication with a cutoff circuit that extends from said handle and upstream of said handle, said handle switch being responsive to hand pressure such that power supply is cutoff upstream of said handle by means of said cutoff circuit upon being pressed inwards towards said handle surface,
wherein the location of said handle switch obviates conscious effort upon the part of a user to press or release said handle switch.

2. The electrode holder in combination with a power cutoff circuit according to claim 1, wherein said handle switch is a trigger switch.

3. Electrode holder with automatic power cutoff, comprising:
a handle having a tubular shape, opposite front and rear ends, and a handle surface;
upper and lower jaw members located at the front opposite end of said handle, said upper jaw member extending for a predetermined distance above said opposite front end of said handle, said upper jaw member pivots about a pivot point in order to allow a user to remove or replace an electrode between said upper and lower jaw members;
a conductive pathway located inside said handle of which at least one of said upper and lower jaws is connected to said conductive pathway;
a trigger switch located on said handle surface and located below said upper jaw member; and
a cutoff circuit, said cutoff circuit comprising said trigger switch, first, second and third cutoff circuit lines, a cutoff switch, and a cutoff circuit power source; and
a power shutoff device located upstream of said handle, wherein said cutoff switch and said cutoff circuit power source are located in said power shutoff device, wherein said first cutoff circuit line connects said trigger switch to said cutoff switch, said second cutoff circuit line connects the cutoff switch to said cutoff circuit power source, and said third cutoff circuit line connects said cutoff circuit power source to said trigger switch.

4. Electrode holder with automatic power cutoff, comprising:
a handle having a tubular shape, opposite front and rear ends, and a handle surface;
upper and lower jaw members located at the front opposite end of said handle, said upper jaw member extending for a predetermined distance above said opposite front end of said handle, said upper jaw member pivots about a pivot point in order to allow a user to remove or replace an electrode between said upper and lower jaw members;
a conductive pathway located inside said handle of which at least one of said upper and lower jaws is connected to said conductive pathway;
a trigger switch located on said handle surface and located below said upper jaw member; and
a cutoff circuit, said cutoff circuit comprising said trigger switch, first, second and third cutoff circuit lines, a cutoff switch, and a cutoff circuit power source; and
a welding power source, wherein said cutoff switch and said cutoff circuit power source are located in said welding power source, wherein said first cutoff circuit line connects said trigger switch to said cutoff switch, said second cutoff circuit line connects the cutoff switch to said cutoff circuit power source, and said third cutoff circuit line connects said cutoff circuit power source to said trigger switch.
